(19) United States
(12) Patent Application Publication
(10) Pub. No.: US 2002/0152050 A1
(43) Pub. Date: Oct. 17, 2002

(54) Orientation and position sensor

(76) Inventor: Charles S. Vann, Burlingame, CA (US)

Correspondence Address: CHARLES S. VANN, 1425 DRAKE AVENUE, BURLINGAME, CA, 94010, US

(21) Appl. No.: 09/777,962

(22) Filed: Feb. 5, 2001

(51) Int. Cl. G01C 9/00

(52) U.S. Cl. 702/150

(57) ABSTRACT

The Orientation and Position Sensor is a compact, non-contact sensor that measures up to three orientations and up to three positions of an alignment target with respect to a camera. The alignment target has two distinct features, and a lens images those features into a camera. From the camera image, an operator or software can interpret the relative position and size of the features to determine the orientation and position of the alignment target with respect to the camera.

### CROSS-REFERENCE TO RELATED APPLICATIONS

None

### BACKGROUND

1. Field of Invention

This invention relates to multi-dimensional orientation and position sensors. This sensor detects up to three-dimensional position, i.e. the distance of an object in along each of the three orthogonal axes from a reference frame. Also, it measures the orientation of that object about each of the three axes of that reference frame.

### BACKGROUND

2. Description of Prior Art

Many types of sensors measure position or orientation on an object relative to a sensor. However, most measure only one position or one orientation of the possible six: three-dimensions of position and three-dimensions of orientations. A few sensors measure two or three dimensions, but cost and complexity increase greatly with an increase in the number measured. A typical three-dimensional position sensor commonly used for measuring accuracy of construction can cost as much as one quarter of a million dollars and provide no information on orientation. Of course, six or more one-dimensional position sensors can be located around an object such that an object's position and orientation can be determined. However, this also is a costly and complex approach with another disadvantage of a workspace that is large and highly susceptible to misalignment.

There are some sensors that measure all three orientations and all three positions, such as the Polhemus. While it is a relatively compact sensor, it has a distinct disadvantage of requiring a metallic target and falters when any additional metal is in the workspace. Since there are usually many metal objects in the workplace, this sensor has very limited application. A sensor called “the flock of birds” attaches to an object and contains six or more accelerometers to identify position and orientation of an object. However, this sensor also has limited application because the object must be moved to work as well as being expensive and awkward.

### SUMMARY

In accordance with the present invention, all orientations and positions are detected with a single sensor, simply and at low cost. The object is tagged with a small, inexpensive alignment target. Unlike the Polhemus sensor, this invention works in a metallic surrounding, and unlike “the flock of birds” it need not be moved to operate.

### Objects and Advantages

Accordingly, several objects and advantages of my invention are:

Reliably measures all three positions and three orientations with one sensor.

Very small size, allows use in space-restricted places other sensors cannot.

As an optical sensor, it does not contact or interfere with object it is sensing.

High-speed operation of many detections/second, enabling it to track objects.

Simple and low-cost, consisting of a camera, optics, target, and monitor.

Capable of sub-millimeter position and sub-milliradian orientation accuracy.

Further objects and advantages of my invention will become apparent from a consideration of the drawings and ensuing description.

### DRAWING FIGURES

Reference is now made to the embodiment of Orientation and Position Sensor illustrated in FIG. 1-4 wherein like numerals are used to designate like parts throughout.

FIG. 1 is an isometric view of first embodiment of Orientation and Position Sensor.

FIG. 2 is a camera image of the alignment target in the reference position and orientation.

FIG. 3 is a camera image of alignment target deviating from reference image of

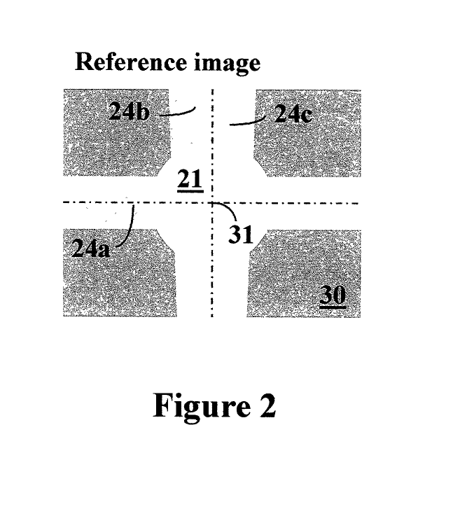

FIG. 2 in each of the positions (Tx, Ty, Tz) and each of the orientations (Rx, Ry, Rz).

FIG. 4 is an isometric view of second embodiment of Orientation and Position Sensor.

Reference Numerals in Drawing

| | |
|---|---|
| 10 | first embodiment |
| 11 | alignment target |
| 12 | camera |
| 13 | lens |
| 14 | optical axis of lens |
| 15 | camera cable |
| 16 | monitor |
| 21 | spot |
| 22 | base |
| 23 | posts |
| 24 | cross-hair |
| 24a-c | cross-hair strands |
| 25 | XYZ reference frame |
| 30 | camera image |
| 31 | center of camera image |
| 40 | second embodiment |
| 41 | computer |

### DESCRIPTION

First Embodiment

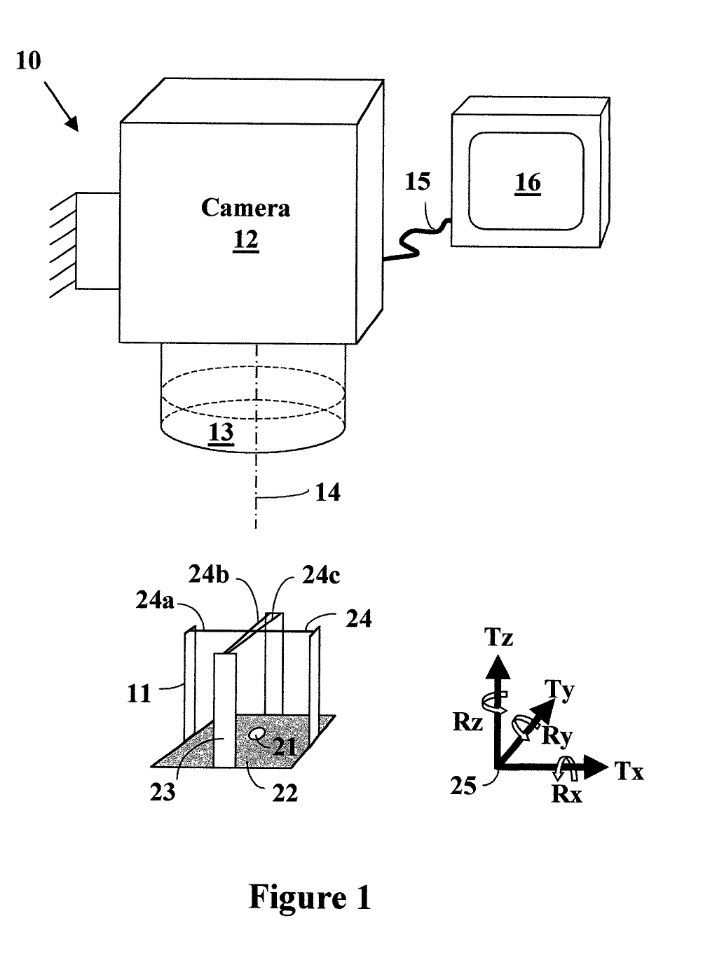

FIG. 1 shows the first embodiment of Orientation and Position Sensor 10 including alignment target 11, camera 12, lens 13 with optical axis 14, cable 15, and monitor 16. In a preferred arrangement, the alignment target 11 includes a circular first-feature 21, base 22, posts 23, and a cross-hair second-feature 24. The first feature 21 is circular, diffusely reflective, and mounted onto base 22. Base 22 is non-reflective for good optical contrast with first feature 21. Posts 23 are mounted on base 22 to support cross-hair 24. Cross-hair 24 consist of several strands, e.g. 24a-c, that could be made of metal, plastic, thread, etc. In the preferred embodiment, strands 24a-c are placed in a non-symmetric arrangement to avoid orientation ambiguity.

Also shown in FIG. 1. is reference frame 25 with three orthogonal axes (XYZ) to describe translation (Tx, Ty, Tz) and orientation (Rx, Ry, Rz) errors.

Operation

Alignment target 11 is placed in the field of view of camera 12 such that camera image 30 contains features 21,24. The relative size and location of those features will be compared to the image 30 of a target 11 perfectly aligned to camera 12.

FIG. 2 shows camera image 30 when alignment target 11 is perfectly aligned with camera 12. This image is referred to hereafter as reference image 30. In reference image 30, features 21, 24 are symmetric about camera center 31 and strand 24a is parallel with horizontal of image 30 and at a preset width as described below.

In the preferred reference image 30, feature 21 is in focus but cross-hair strands 24a-c are not in focus. Out of focus, strands 24a-c are blurred and the width of the blur varies linearly and sensitively to the distance between alignment target 11 and camera 12, i.e. translation along the Z axis. Therefore, establishing a preset width of 24a defines a distance between alignment target 11 and camera 12 as the Z-axis reference position.

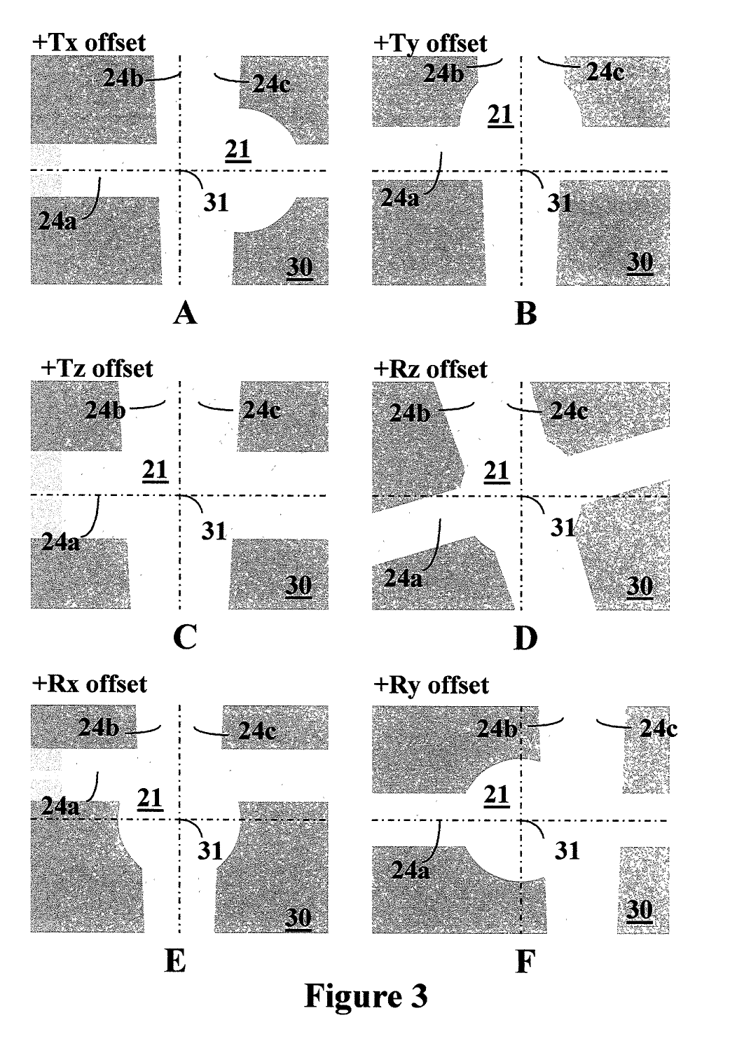

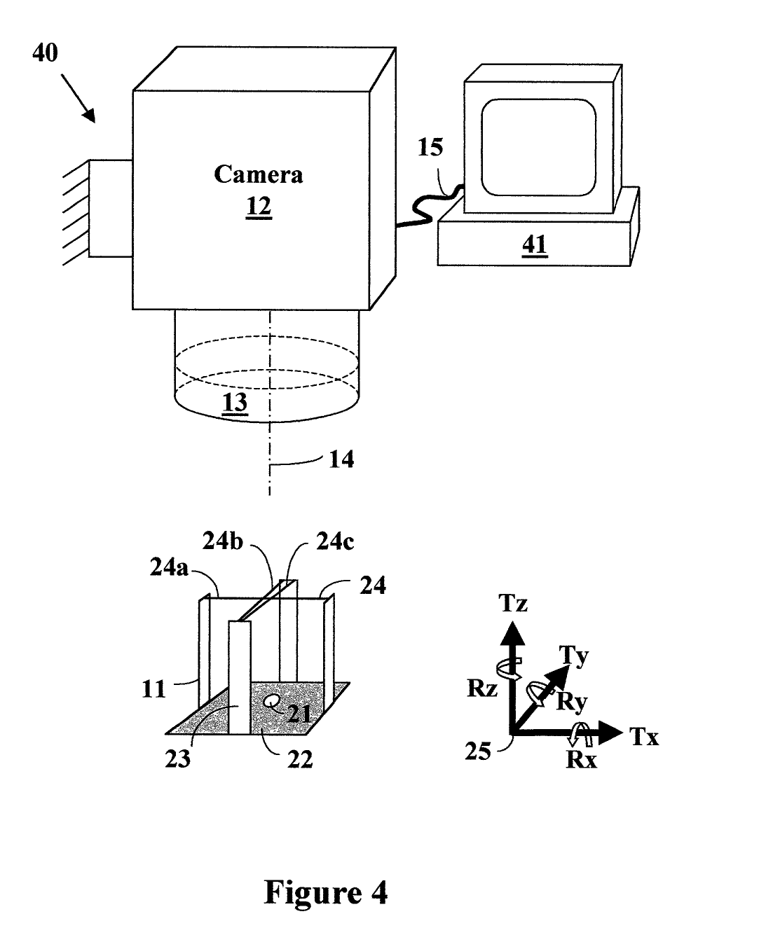

FIG. 3 shows camera image 30 when alignment target 11 is not perfectly aligned with camera 12, including an image 30 for each alignment error in translation (Tx, Ty, Tz) and an image 30 for each error in orientation (Rx, Ry, Rz). As shown, image 30 for each error is unique from the other images 30, enabling an operator to easily distinguish one error from another or combinations of many errors.

FIG. 3A shows camera image 30 when alignment target 11 has a positive X axes translation error with respect to reference image 30. Spot 21 and strands 24b, c are located right-horizontal from camera center 31 while the location of strand 26a remains symmetric about camera center 31, parallel to camera horizontal, and the same width.

FIG. 3B shows camera image 30 when alignment target 11 has a positive Y axes translation error with respect to reference image 30. Spot 21 and strands 26a are located up-vertical from camera center 31 while the location of strand 24b, c remains symmetric about camera center 31, and strand 26a remains parallel to camera horizontal and the same width.

FIG. 3C shows camera image 30 when alignment target 11 has a positive Z axes translation error with respect to reference image 30. Strand 26a is more out of focus and the blur becomes wider while spot 21 and strands 26a-c remain symmetric about camera center 31 and strand 26a remains parallel to camera horizontal.

FIG. 3D shows camera image 30 when alignment target 11 has a positive Z axes orientation error with respect to reference image 30. Strand 26a rotates from camera horizontal while spot 21 and strands 26a-c remain symmetric about camera center 31 and strand 26a remains the same width.

FIG. 3E shows camera image 30 when alignment target 11 has a positive X axes orientation error with respect to reference image 30. Strand 26a is located up-vertical from camera center 31 while the location of spot 21 and strands 24b, c remain symmetric about camera center 31, and strand 26a remains parallel to camera horizontal, and the same width.

FIG. 3F shows camera image 30 when alignment target 11 has a positive Y axes orientation error with respect to reference image 30. Strand 24c-d are located righ-horizontal from camera center 31 while the location of spot 21 and strands 26a remain symmetric about camera center 31, and strand 26a remains parallel to camera horizontal, and the same width.

### DESCRIPTION

Second Embodiment

FIG. 4 shows the second embodiment 40 of Orientation and Position Sensor that includes all components of first embodiment 10 except monitor 16 is replaced with computer 41. Software in computer 41 process images from camera 12 and interprets the position and orientation of alignment target 11 to camera 12.

Advantages

The Orientation and Position Sensor is a substantial advance in the state of the art of multi-dimensional measurement sensors. Because of the small size of cameras, this sensor is extremely small. Because of the large number of pixels in most cameras, the resolution is high. Its simple design and low cost make it practical for many applications. The sensor is ideally suited for providing feedback for medical and industrial robots with many degrees of freedom, even up to the maximum of six. The number of other applications is large because it is so adaptable, compact, inexpensive, and easy to use.

Conclusions, Ramifications, and Scope

This invention is capable of measuring variations in all positions and all orientations. The sensor is compact, accurate but simple and inexpensive. This sensor will be of major benefit to automated machines such as robots functioning in all positions and orientations. Presently there are no robot sensors that provide feedback for more than three axis of operation, leaving three and often more axes without feedback. This lack of feedback is a major source of error and inefficiency. The Orientation and Position Sensor will be a practical and effective solution to this problem.

I claim:

1. A sensor for measuring position and orientation of an object, comprising:
a camera;
a lens;
a first feature of an alignment target;
a second feature of an alignment target;
whereby the relative position and size of the first feature and second feature in the camera image are interpreted to measure up to three orthogonal positions and up to three orthogonal orientations of said alignment target with respect to said camera. The sensor of claim 1 further including a monitor. The sensor of claim 1 further including a computer.
